(19) United States
(12) Patent Application Publication
(10) Pub. No.: US 2022/0058517 A1
(43) Pub. Date: Feb. 24, 2022

(54) METHOD, SYSTEM AND APPARATUS FOR CUSTOM PREDICTIVE MODELING

(71) Applicant: BATON SIMULATIONS, Montreal (CA)

(72) Inventors: Sebastien CHERRY, Saint-Lambert (CA); Stephane GOSSELIN, Montreal (CA)

(21) Appl. No.: 16/999,910

(22) Filed: Aug. 21, 2020

(51) Int. Cl. G06N 20/00; G06F 16/28; G06F 16/2453; G06F 16/2455

(52) U.S. Cl. CPC G06N 20/00; G06F 16/2456; G06F 16/24535; G06F 16/287

(57) ABSTRACT

The disclosed systems, apparatus, and methods are directed to generating custom predictive model, the method comprising selecting, in a user interface (UI), a business object, selecting, in the UI, a machine learning algorithm, fetching, from a database, data fields associated with the business object, configuring, in the UI, the machine learning algorithm with the data fields associated with the business object, creating, in the UI, a mathematical expression defining a relationship among the data fields, and processing, by the machine learning algorithm, the data fields associated with the business object in accordance with the mathematical expression defining the relationship among the data fields to generate predictive values.

### CROSS-REFERENCE TO RELATED APPLICATIONS

This is the first application filed for the instantly disclosed technology.

### FIELD OF THE INVENTION

The present invention generally relates to an enterprise resource planning (ERP) system and, in particular, to a system, method, and computing device for custom predictive modeling.

### BACKGROUND

Enterprise resource planning (ERP) system is an integrated management of main business processes mediated by software and technology. The ERP systems have grown into robust offerings that provide dynamic service. In general, the ERP system is referred to as a category of business management software, typically a combination of integrated applications, that an organization can use to collect, store, manage, and interpret data from many business activities.

Generally, the ERP system uses common databases maintained by a database management system to provide an integrated and continuously updated view of core business processes. Certain ERP systems track business resources such as cash, raw materials, production capacity or the like along with the status of business commitments such as orders, purchase orders, and payroll or the like. The integrated applications associated with the ERP system share data across various departments (manufacturing, purchasing, sales, accounting, etc.) that provide the data.

The ERP system utilizes the various predictive models that assist a user of the ERP system to perform various sorts of data analytics to reach to a business decision. Typically, building such predictive models requires a time-consuming manual process of coding and cumbersome hardware and software infrastructure. To this end, there is an interest in developing an ERP system that may assist the user build and generate predictive models without using complex hardware and software infrastructure.

### BRIEF DESCRIPTION OF THE FIGURES

Further features and advantages of the present disclosure will become apparent from the following detailed description, taken in combination with the appended drawings, in which:

FIG. 1 depicts an enterprise resource planning (ERP) system, in accordance with various embodiments of the present disclosure;

FIG. 2A depicts a high level functional block diagram of a client device of the ERP system of FIG. 1, in accordance with various embodiments of the present disclosure;

FIG. 2B depicts a high level functional block diagram of an ERP server of the ERP system of FIG. 1, in accordance with various embodiments of the present disclosure;

FIG. 2C depicts a high level functional block diagram of an ERP environment implemented on the ERP system of FIG. 1, in accordance with various embodiments of the present disclosure;

FIG. 2D depicts a high level functional block diagram of a view generator included in the ERP environment, in accordance with various embodiments of the present disclosure;

FIG. 3A-3Q illustrate examples of a graphic user interface (GUI) associated with the ERP system, in accordance with various embodiments of present disclosure;

FIGS. 4A-4C depicts flowcharts representing processes corresponding to a generation of SQL scripts and Application Programming Language (ABAP) Core Data Service (CDS) view implemented on the one or more components of the view generator 272, in accordance with various embodiments of the present disclosure; and

FIG. 5 depicts a flowchart representing a process corresponding to a custom predictive modeling method implemented on the ERP system, in accordance with various embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### SUMMARY

Embodiments of the present technology have been developed based on developers' appreciation of shortcomings associated with the prior art.

In particular, such shortcomings may comprise (1) Manual generation of predictive models; (2) Manual generation of database views; and/or (3) Manual generation and activation of OData services.

In accordance with the first broad aspect of the present disclosure, there is provided method for generating custom predictive model, the method comprising:
selecting, in a user interface (UI), a business object;
selecting, in the UI, a machine learning algorithm;
fetching, from a database, data fields associated with the business object;
configuring, in the UI, the machine learning algorithm with the data fields associated with the business object;
creating, in the UI, a mathematical expression defining a relationship among the data fields; and
processing, by the machine learning algorithm, the data fields associated with the business object in accordance with the mathematical expression defining the relationship among the data fields to generate predictive values.

In accordance with other aspects of the present disclosure, the method further comprises configuring a visualization application to provide a visualization of the predictive values.

In accordance with other aspects of the present disclosure, the method further comprises generating, by a query script generator, an SQL query script, the SQL query script is associated with the data fields and the mathematical expression defining relationship among the data fields.

In accordance with other aspects of the present disclosure, the method, wherein the generating the SQL query script comprises:
adding database tables associated with the business object to a list L₁;
selecting an entity included in the business object;
validating if the data fields associated with the entity are not retrieved from multiple business objects;
validating if the data fields associated with the entity are not retrieved from multiple descendant paths;
selecting a foreign key field between a database table associated with the entity and a database table in the list L₁ having a same name as that of the database table associated with the entity;
building a part of SQL INNER JOIN clause to match the database table associated with the entity and the database table in the list L₁ having the same name as that of the database table associated with the entity;
selecting a primary key field associated with the database table associated with the entity;
building a part of SQL concatenation statement to concatenate data values associated with the primary key field; and
adding the part of SQL INNER JOIN clause and the part of SQL concatenation statement to a list L₂.

In accordance with other aspects of the present disclosure, the method further comprises generating, by a database view generator, a database view using the SQL query script.

In accordance with other aspects of the present disclosure, the method wherein generating the database view comprises:
adding a first selection part of an SQL statement to query a first database table in the list L₂;
selecting a database table from the list L₂ other than the first database table;
adding a part of SQL INNER JOIN of the SQL statement to the part of SQL INNER JOIN clause;
adding a primary key associated with the first database table for an SQL view;
adding a second part of the SQL statement to include the first database table and/or mathematical expression defining relationship among the data fields; and
adding a third part of the SQL statement to include the selection filters in a where clause.

In accordance with other aspects of the present disclosure, the method, wherein the database view is an Application Programming Language (ABAP) Core Data Service (CDS) view.

In accordance with other aspects of the present disclosure, the method further comprises generating and activating, by an OData generator using the database view, OData services.

In accordance with other aspects of the present disclosure, the method, wherein activating the OData services includes using: I) default technical service name, II) default external service name, III) version.

In accordance with other aspects of the present disclosure, the method further comprises activating, by the OData generator, a standard internet communication framework (ICF) node.

In accordance with other aspects of the present disclosure, the method further comprises adding, by the OData generator, a default system alias.

In accordance with other aspects of the present disclosure, the method further comprises assigning, by the OData generator, the activated OData services to ABAP packages.

In accordance with other aspects of the present disclosure, the method further comprises training the machine learning algorithm using the predicted values for further forecasting.

In accordance with other aspects of the present disclosure, the method further comprises providing a user notification when the predictive values: I) fall below a threshold values or II) overpass a threshold values.

In accordance with the second broad aspect of the present disclosure, there is provided a system for generating custom predictive model, the system comprising:
a processor;
a non-transitory computer-readable medium comprising instructions, the processor;
upon executing the instructions, being configured to cause the processor to:
   select, in a user interface (UI), a business object;
   select, in the UI, a machine learning algorithm;
   fetch, from a database, data fields associated with the business object;
   configure, in the UI, the machine learning algorithm with the data fields associated with the business object;
   create, in the UI, a mathematical expression defining a relationship among the data fields; and
   process, by the machine learning algorithm, the data fields associated with the business object in accordance with the mathematical expression defining the relationship among the data fields to generate predictive values.

In accordance with other aspects of the present disclosure, the system further comprises generating, by a query script generator, an SQL query script, the SQL query script is associated with the data fields and the mathematical expression defining relationship among the data fields, wherein the generating the SQL query script comprises:
adding database tables associated with the business object to a list L₁;
selecting an entity included in the business object;
validating if the data fields associated with the entity are not retrieved from multiple business objects;
validating if the data fields associated with the entity are not retrieved from multiple descendant paths;
selecting a foreign key field between a database table associated with the entity and a database table in the list L₁ having a same name as that of the database table associated with the entity;
building a part of SQL INNER JOIN clause to match the database table associated with the entity and the database table in the list L₁ having the same name as that of the database table associated with the entity;
selecting a primary key field associated with the database table associated with the entity;
building a part of SQL concatenation statement to concatenate data values associated with the primary key field; and
adding the part of SQL INNER JOIN clause and the part of SQL concatenation statement to a list L₂.

In accordance with other aspects of the present disclosure, the system further comprises generating, by a database view generator, a database view using the SQL query script, wherein generating the database view comprises:
adding a first selection part of an SQL statement to query a first database table in the list L₂;
selecting a database table from the list L₂ other than the first database table;
adding a part of SQL INNER JOIN of the SQL statement to the part of SQL INNER JOIN clause;
adding a primary key associated with the first database table for an SQL view;
adding a second part of the SQL statement to include the first database table and/or mathematical expression defining relationship among the data fields; and
adding a third part of the SQL statement to include the selection filters in a where clause.

In accordance with other aspects of the present disclosure, the system further comprises generating and activating, by an OData generator using the database view, OData services.

In accordance with other aspects of the present disclosure, the system, wherein activating the OData services includes using: I) default technical service name, II) default external service name, III) version.

In accordance with other aspects of the present disclosure, the system further comprises:
activating, by the OData generator, a standard internet communication framework (ICF) node;
adding, by the OData generator, a default system alias; and
assigning, by the OData generator, the activated OData services to ABAP packages.

### DETAILED DESCRIPTION

The instant disclosure is directed to address at least some of the deficiencies of the current technology. In particular, the instant disclosure describes a system, method, and computing device for custom predictive modeling.

In the context of the present specification, a “server” is a physical machine, a virtual machine, or computer program (e.g. software) running on appropriate physical or virtual machine, and is capable of receiving requests from “clients”, and carrying out those requests, or causing those requests to be carried out. The physical machine may be one physical computer or one physical computer system, but neither is required to be the case with respect to the present technology. A virtual machine is a virtual representation of one physical machine or one physical computer system. In the present context, the use of the expression a “server” is not intended to mean that every task (e.g. received instructions or requests) or any particular task will have been received, carried out, or caused to be carried out, by the same server (i.e. the same software and/or machine); it is intended to mean that any number of software modules, routines or functions, or hardware devices may be involved in receiving/sending, carrying out or causing to be carried out any task or request, or the consequences of any task or request; and all of this software and hardware may be one server or multiple servers, both of which are included within the expression “one server”.

In the context of the present specification, “client device” is any computer hardware that is capable of running software appropriate to the relevant task at hand. In the context of the present specification, in general the term “client device” is associated with a user of the client device. Thus, some (non-limiting) examples of client devices include personal computers (desktops, laptops, netbooks, etc.), smart phones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, the expression “information” includes information of any nature or kind. Thus information includes, but is not limited to audiovisual works (images, movies, sound records, presentations, etc.), data (location data, numerical data, etc.), text (opinions, comments, questions, messages, etc.), documents, spreadsheets, etc.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU), a tensor processor unit (TPU), a neural processing unit (NPU). Moreover, explicit use of the term “processor” should not be construed to refer exclusively to hardware capable of executing software, and may implicitly include, without limitation, an arithmetic and logic unit, a control unit, and a memory unit for storing instructions, data, and intermediate results, and a hardware accelerator in the form of an application specific-integrated circuit or field programmable gate array configured to perform hardware acceleration. Other hardware, conventional and/or custom, may also be included.

Software modules, simply modules, or applications, which are implied to be software, may be represented herein as any combination of flowchart elements or other elements indicating performance of process steps and/or textual description. Such modules and applications may be executed by hardware that is expressly or implicitly shown.

With these fundamentals in place, the instant disclosure is directed to address at least some of the deficiencies of the current technology. In particular, the instant disclosure describes a system, method, and computing device for custom predictive modeling.

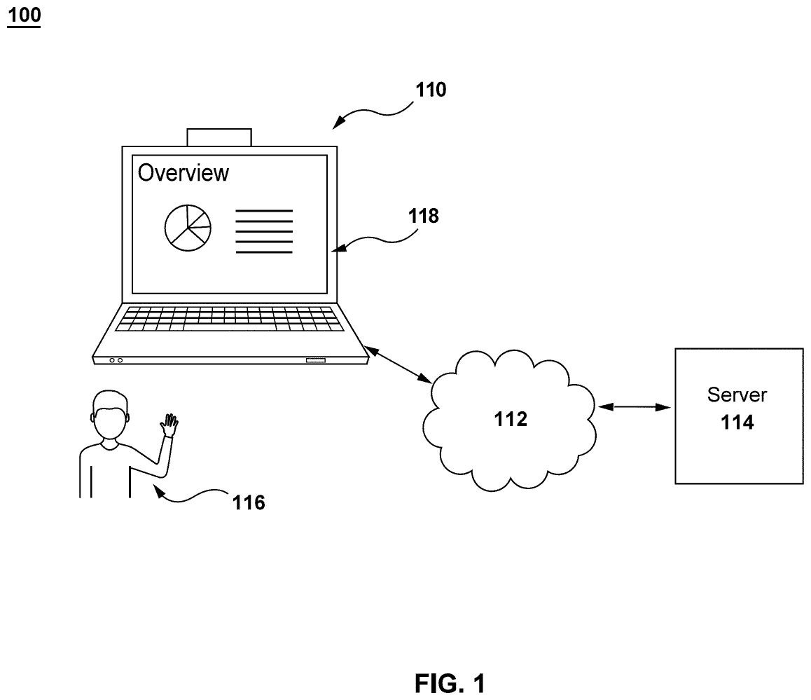

FIG. 1 depicts an enterprise resource planning (ERP) system 100, in accordance with an embodiment of the present disclosure. The ERP system 100 may include multiple client devices 110 (for the purpose of simplicity only one client device 110 has been illustrated) located and different geographic locations that are configured to communicate with each other via a communication network 112 and an ERP server 114. The multiple client devices 110 may be associated with (e.g., used by) users (i.e., user 116) of the ERP system 100. Although FIG. 1 shows one client device 110 associated with one user 116, it will be appreciated that in alternative embodiments, the ERP system 100 may include any number of client devices 110 associated with any number of users 116. Also, in other alternative embodiments, the client device 110 may be associated with multiple users 116.

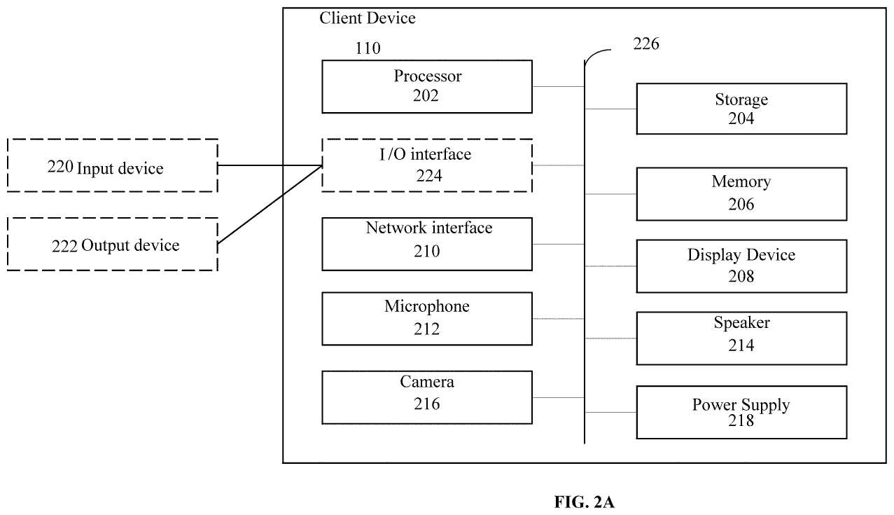

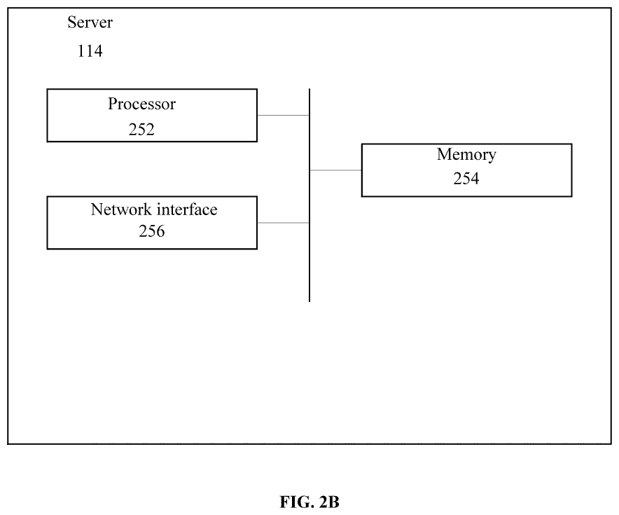

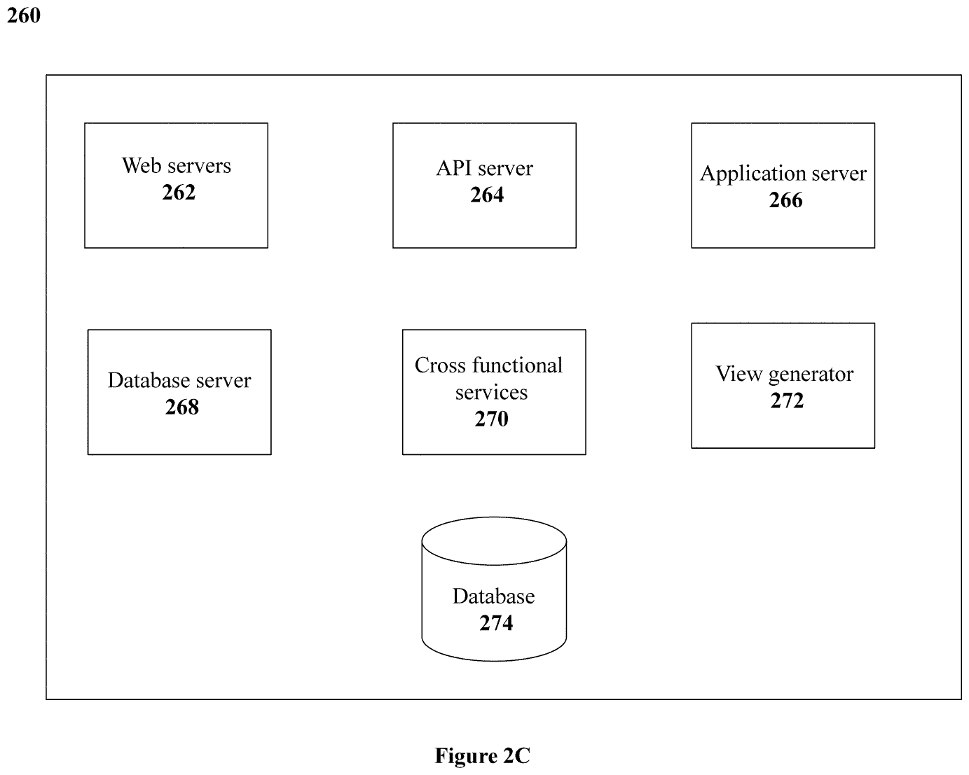

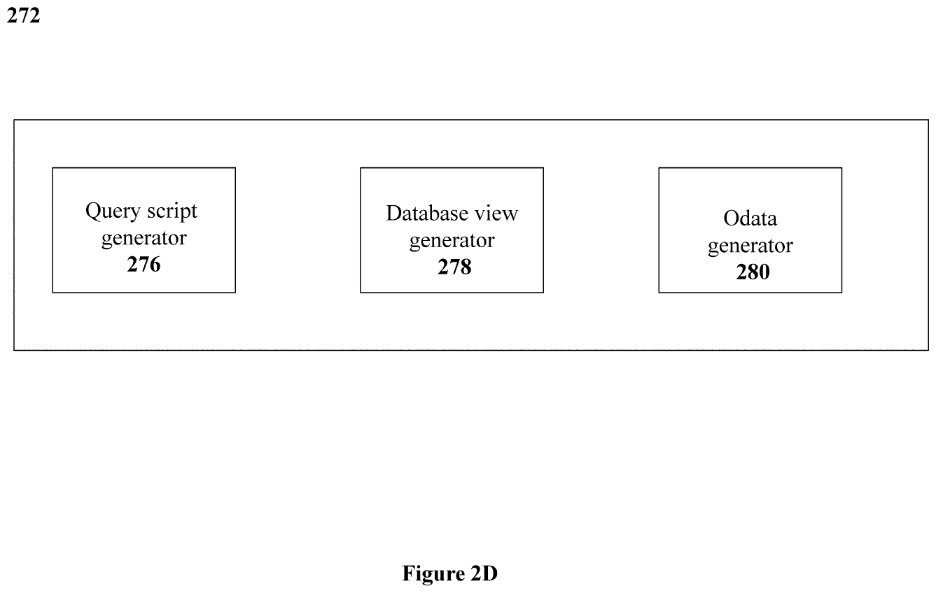

FIG. 2A depicts a high level functional block diagram of the client device 110 in accordance with an embodiment of the present disclosure. The client device 110 may be any suitable type of computing device, including desktop computer, laptop computer, tablet, smartphone, portable electronic device, mobile computing device, and the like. The client device 110 includes multiple components, including a processor 202 that controls the overall operation of the client device 110. The processor 202 is coupled to and interacts with other components of the client device 110, including one or more storage units 204, one or more memories 206, a display device 208 (hereinafter referred to as display 208), a network interface 210, a microphone 212, and a speaker 214, and camera 216 (interchangeably used with image sensor 216). The client device 110 also includes a power supply 218 that powers the components of the client device 110, including the memory 206, the display 208, the network interface 210, the microphone 212, the speaker 214, and the camera 216. The power supply 218 may include a battery, a power pack, micro fuel cells and like, however, in other embodiments, the power supply 218 may include a port (not shown) to an external power supply and a power adaptor (not shown), such as an alternating current to direct current (AC-to-DC) adopter that provides power to components of the client device 110. Optionally, the client device 110 includes one or more input devices 220, one or more output devices 222 and an I/O interface 222.

The processor 202 of the client device 110 may include one or more of a central processing unit (CPU), an accelerator, a microprocessor, a graphics processing unit (GPU), a tensor processing unit (TPU), a neural processing unit (NPU), an application-specific integrated circuit (ASIC), a field-programmable gate array (FPGA), a dedicated logic circuitry, a dedicated artificial intelligence processor unit, or combinations thereof.

The processor 202 is configured to communicate with the storage unit 204, which may include a mass storage unit such as a solid state drive, a hard disk drive, a magnetic disk drive and/or an optical disk drive. The processor 202 is also configured to communicate with the memory(ies) 206, which may include volatile memory (e.g. random access memory (RAM)) and non-volatile or non-transitory memory (e.g., a flash memory, magnetic storage, and/or a read-only memory (ROM)). The non-transitory memory(ies) store applications or programs that include software instructions for execution by the processor 202, such as to carry out examples described in the present disclosure. The non-transitory memory store an ERP application as described in further detail below. Examples of non-transitory computer readable media include a RAM, a ROM, an erasable programmable ROM (EPROM), an electrically erasable programmable ROM (EEPROM), a flash memory, a CD-ROM, or other portable memory storage.

The processor 202 is also configured to communicate with the display 208, which includes any one of flat panel display (e.g. liquid crystal display, a plasma display, a light emitting diode (LED) display, an organic light emitting diode display (OLED)), touchscreen display such as a capacitive, resistance, surface acoustic wave (SAW) or optical touchscreen display, and the like.

The processor 202 is further configured to interact with the network interface 210. The network interface 210 may include one or more radios configured for wireless communications (e.g. cellular or WiFi communications) with the communication network 112, or one or more network adaptors configured for wired communications with the communication network 112. In general, the network interface 210 is configured to correspond with the network architecture of that is used to implement a link for communications between the client device 110 and the communication network 112. The communication network 112 may be internet, local area network, wide area network or the like.

The processor 202 is further configured to interact with the microphone 212, the speaker 214, and the camera 216. The microphone 210 includes any suitable transducer that converts sound to audio signals and provides audio signals to the processor 202 for processing and/or transmission to other client devices 110. The speaker 214 includes any suitable transducer receives audio signal from the processor 202 and converts an audio signal received from the processor 202 into sound waves. The camera 216 is configured to capture video (e.g. a sequence of digital images) in a field of view of the camera 216 and provide the captured video to the processor 202 for processing. The camera 216 may be any suitable digital camera, such as a high-definition image camera, an infrared camera, a stereo camera and the like. In some embodiments, the microphone 210, the speaker 214, and the camera 216 may be internally integrated to the client device 110. In other embodiments, the microphone 210, the speaker 214, and the camera 216 may be coupled external to the client device 110.

Optionally, the processor 202 may communicate with an input/output (I/O) interfaces 222, which may enable interfacing the one or more input devices 220 (e.g., a keyboard, a mouse, a joystick, trackball, fingerprint detector and the like) and/or output devices 222 (e.g., a printer, peripheral display device, and the like).

The client device 110 also includes a bus 226 providing communication among the components of the client device 110, including the processor 202, the memory 206, the display 208, the network interface 210, the microphone 212, the speaker 216, and the camera 216. The bus 226 may be any suitable bus architecture including, for example, a memory bus, a peripheral bus or a video bus.

FIG. 2B depicts a high level functional block diagram of the ERP server 114 in accordance with an embodiment of the present disclosure. In this embodiment, the ERP server 114 is a physical machine (e.g. a physical server) or virtual machine (e.g. a virtual server) that executes ERP software to enable the client devices 110 to communicate with the server 114. The ERP server 114 includes a processor 252, a memory 254, and a network interface 256.

The processor 252 of the ERP server 114 may include one or more of a CPU, an accelerator, a microprocessor, a GPU, an ASIC, a FPGA, a dedicated logic circuitry, a dedicated artificial intelligence processor unit, or combinations thereof.

The memory 254 may include volatile memory (e.g. RAM) and non-volatile or non-transitory memory (e.g., a flash memory, magnetic storage, and/or a ROM). The non-transitory memory(ies) stores a platform that controls the overall operation of the ERP server 114. The platform, when executed by the processor 252, implements an ERP service. The platform stores in the memory a unique identifier for each user of the ERP service and manages the unique identifier or each user of the ERP service. The unique identifier for a user may be a username or an email address of the user. A password may also be associated with the unique identifier for a user and stored in the memory 254.

The network interface 256 may include one or more radios configured for wireless communications with the communication network 112, or one or more network adaptors configured for wired communications with the communication network 112. In general, the network interface 256 is configured to correspond with the network architecture of that is used to implement a link for communications between the ERP server 114 and the communication network 112.

It is to be noted that the ERP server 114 is shown as a standalone computer. However, the implementation of various other embodiments of the present disclosure may include any client-server model where client devices may run a client version of the ERP software. Other examples of the server 250 may include a distributed computing system that runs the server version of the ERP software, a virtual machine (or virtual machines) instantiated by the infrastructure of a public or private cloud, or a cloud service provider that provides the ERP software as a service (SaaS). Such implementations or any other similar implementation should not limit the scope of present disclosure.

In other non-limiting embodiments, the client device 110 may use a web browser, such as, for example, Chrome™, Safari™, Mozilla™, or the like to facilitate ERP services. It is to be noted that how the client devices 110 are configured to facilitate ERP services should not limit the scope of the present disclosure by any means.

FIG. 2C depicts a high level functional block diagram of an ERP environment 260 implemented on the ERP system 100 of FIG. 1, in accordance with various embodiments of the present disclosure. As shown, the ERP environment 260 may include a web server 262, an Application Program Interface (API) server 264, an application server 266, a database server 268, cross functional services 270, a view generator 272 and a database 274. It is to be noted that the ERP environment 260 may include other components or modules but have not illustrated for the purpose of simplicity.

In certain embodiments, the ERP environment 260 and the associated modules and components may be implemented on the client device 110. In other embodiments, the ERP environment 260 and the associated modules and components may be implemented on the server 114. In yet another embodiment, some of the modules and components of the ERP environment 260 may be implemented on the client device 110 while other modules and components may be implemented on the server 114. It is contemplated that where the ERP environment 260 has been implemented should not limit the scope present disclosure.

In certain embodiments, the web servers 262 and API server 264 may be coupled to and provide web and programmatic interfaces to the application server 266. The application server 266 may be coupled to the database server 268. As such the database server 268 may facilitate access to the database 274. It is contemplated that different servers may communicate with each other.

In certain embodiments, the web server 262, API server 264, application server 266, and database server 268 may host cross-functional services 270. In certain embodiments, the application server 266 may further host domain applications.

In certain embodiments, the cross-functional services 270 may provide services to user 116 and processes that utilize the ERP environment 260. For instance, the cross-functional services 270 may provide portal services (e.g., web services), database services and connectivity to the host domain applications for user 116 that operate the client device 110. In addition, the cross-functional services 270 may provide an environment for delivering enhancements to existing applications and for integrating third-party and legacy applications with existing cross-functional services 270 and host domain applications.

In certain embodiments, the cross-functional services 270 may include portal module, relational database module, connector messaging module, API module, and development module. In certain embodiments, the portal module may enable a single point of access to other cross-functional services and host domain applications for the client device 110. The portal module may be utilized to process, author and maintain web pages that present content (e.g., user interface elements and navigational controls) to the user 116. In addition, the portal module may enable user roles, a construct that associates a role with a specialized environment that is utilized by the user 116 to execute tasks, utilize services and exchange information with other users 116 and within a defined scope. For example, the role may determine the content that is available to the user 116 and the activities that the user 116 may perform. The portal modules 140 include a generation module, a communication module, a receiving module and a regenerating module. In addition, the portal module may comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

In certain embodiments, the relational database module may provide support services for access to the database(s) 274, which may further include a user interface library. The relational database module may provide support for object relational mapping, database independence and distributed computing. The relational database module may be utilized to add, delete, update and manage database fields. In addition, the relational database module may comply with database standards and/or utilize a variety of database technologies including SQL, SQLDBC, Oracle, MySQL, Unicode, JDBC, or the like.

In certain embodiments, the connector and messaging module may enable communication across different types of messaging systems that may be utilized by the cross-functional services and the host domain applications by providing a common messaging application processing interface. The connector and messaging module may enable asynchronous communication on the ERP environment 260.

In certain embodiments, the API module may enable the development of service-based applications by exposing an interface to existing and new applications as services. In certain embodiments, repositories may be included in the platform as a central place to find available services when building applications.

In certain embodiments, development module may provide a development environment for the addition, integration, updating and extension of software components on the ERP environment 260 without impacting existing cross-functional services and host domain applications.

FIG. 2D depicts a high level functional block diagram of the view generator 272 included in the ERP environment 260, in accordance with various embodiments of the present disclosure. As shown, the view generator 272 includes a query script generator 276, a database view generator 278, and an OData service generator 280. It is to be noted that the view generator 272 may include other components or modules but have not illustrated for the purpose of simplicity.

In certain embodiments, the query script generator 276 may be configured to generate structured query language (SQL) scripts having one more SQL statements (e.g. SELECT statements, etc.) for the selected data fields associated with one or more database tables stored in the database 276.

In certain embodiments, the database view generator 278 may be configured to generate database views (e.g. ABAP Core Data Service (CDS) view) from the generated SQL scripts. For example, the database view generator 278 may be capable of creating one or more database views on one or more underlying database tables. In certain embodiments, the database view may expose a database table (or portion thereof) or multiple database tables (or portions of multiple database tables). In certain embodiments, the database view generator 278 may automatically generate a complete database view that accounts for any customization applied to the database tables.

In certain embodiments, the database tables may store transactional data. By way of examples, the transactional data may include but not limited to financial orders, invoices, payments, plans, activity records, deliveries, storage records, travel records, involving anything from a purchase order, shipping status, employee hours worked, insurance costs and claims or the like. In certain embodiments, the database tables may be considered transactional processing database tables. In certain embodiments, the database tables may be capable of storing a high number of database transactions. In certain embodiments, the database tables may be capable of storing over a million transactions. In certain embodiments, each transaction may be defined as one or more database items.

In certain embodiments, the database view may include logic that defines a view of the underlying data contained in one or more database tables. In certain embodiments, the database view may be considered as a customized database view in the sense that it captures data fields from one or more custom database tables. In certain embodiments, the database view may include logic that arranges data fields from the database tables in a specific order, illustrating only certain fields from the database tables, highlighting certain fields from the database tables, or may include calculation logic (e.g., combining items in a certain way). In certain embodiments, the database view may be one or more SELECT queries that have been given a name and saved. In certain embodiments, the database view may be considered a named query or a stored query. Once stored, in certain embodiments, the database view may be reused instead of re-writing the same query again. In certain embodiments, the database view may provide a logic that joins two or more database tables. In certain embodiments, the database view may include complex logic or calculations on the underlying data of two or more database tables.

After the database view is generated, the OData generator 280 may be configured to generate OData services from the generated database view. In certain embodiments, OData services may allows the creation and consumption of APIs in order to exchange information over a network between client device 110 and the view generator 272.

Returning to FIG. 1, in certain embodiments, the ERP system 100 may be implemented any suitable virtual environment (e.g. transactional applications) and may facilitate any suitable user interface to act as a bridge between the ERP system 100 and the user 116. In certain embodiments, the user interface may a graphic user interface (GUI) 118. It is to be noted that without limiting the scope of present disclosure, the GUI 118 may be based on any other suitable techniques.

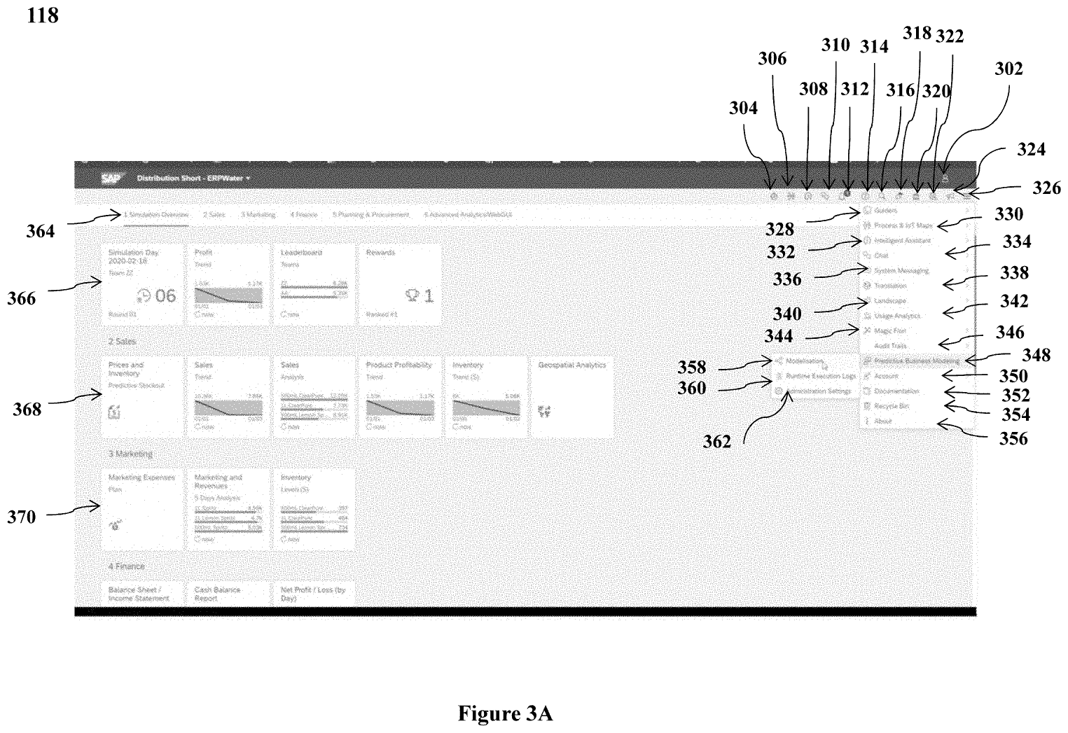

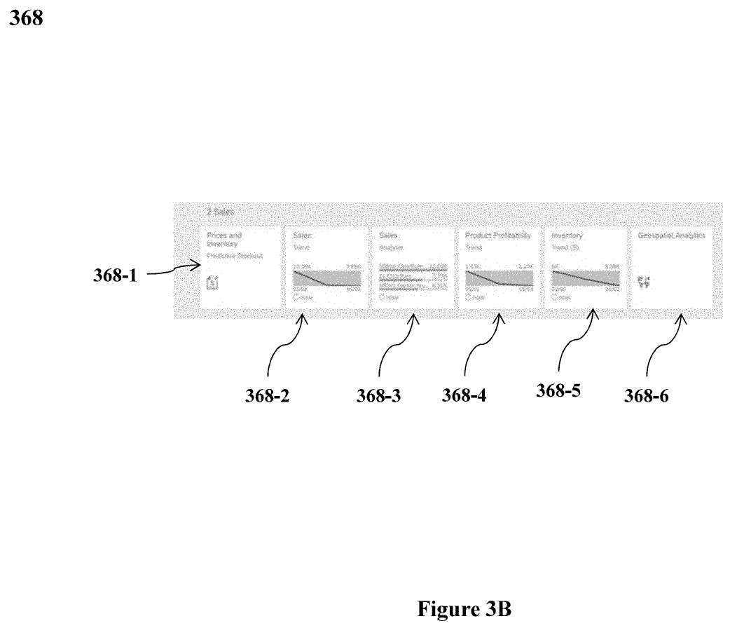

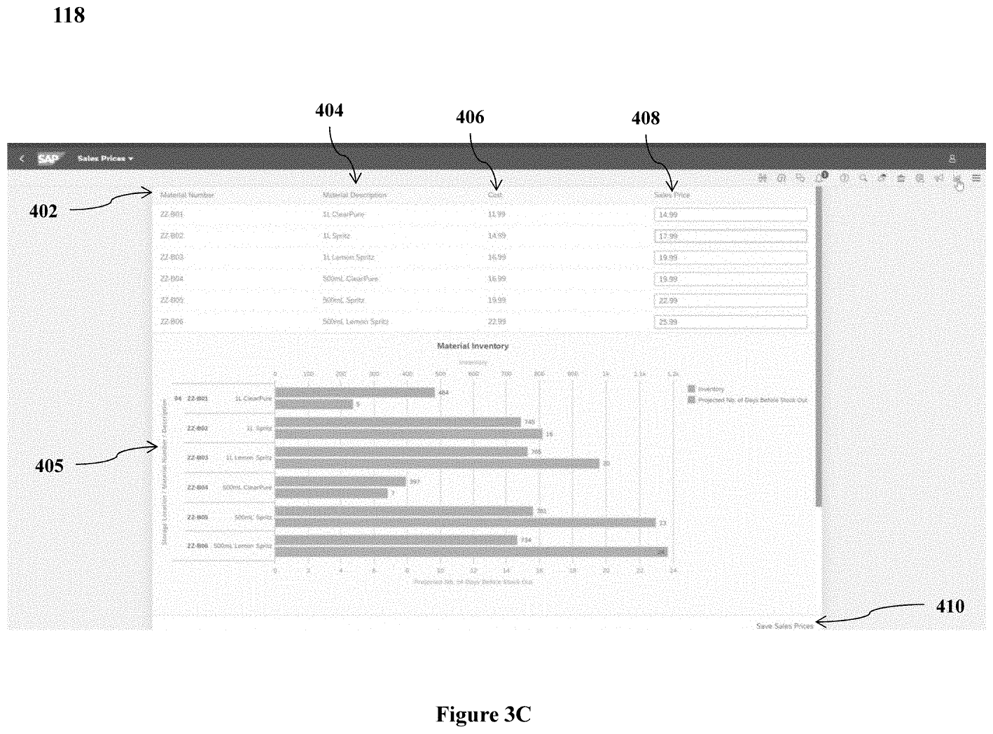

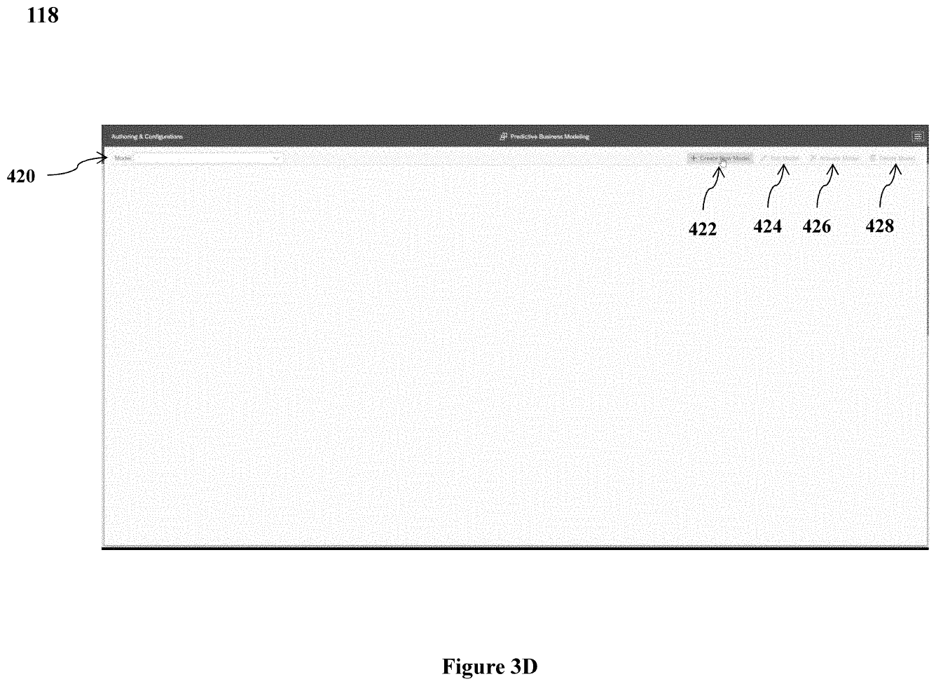

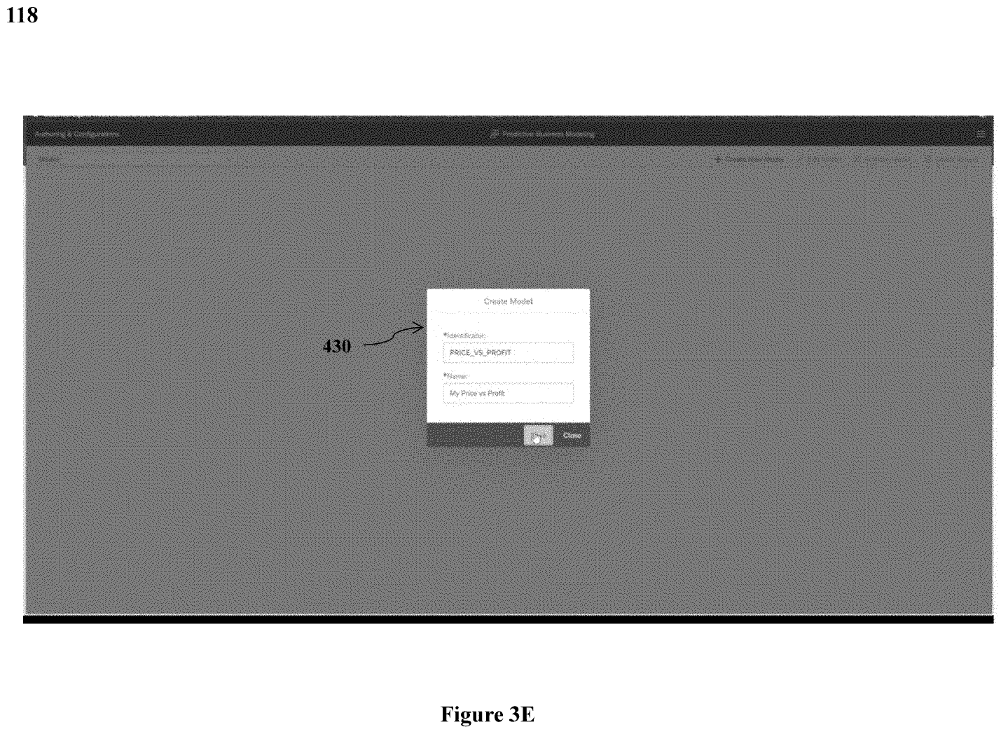

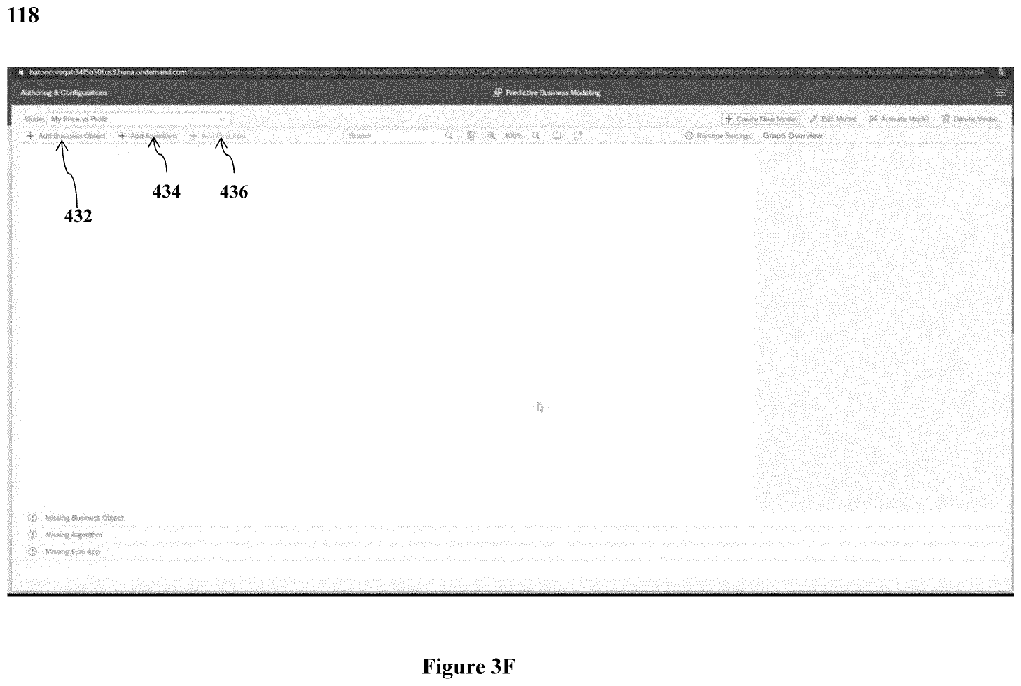

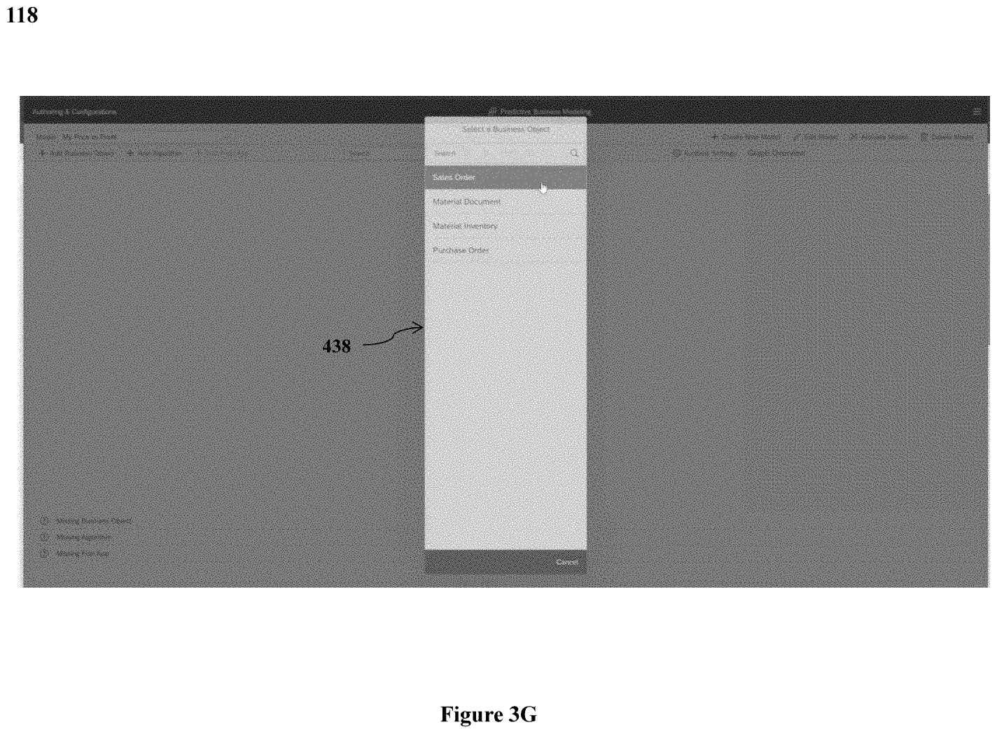

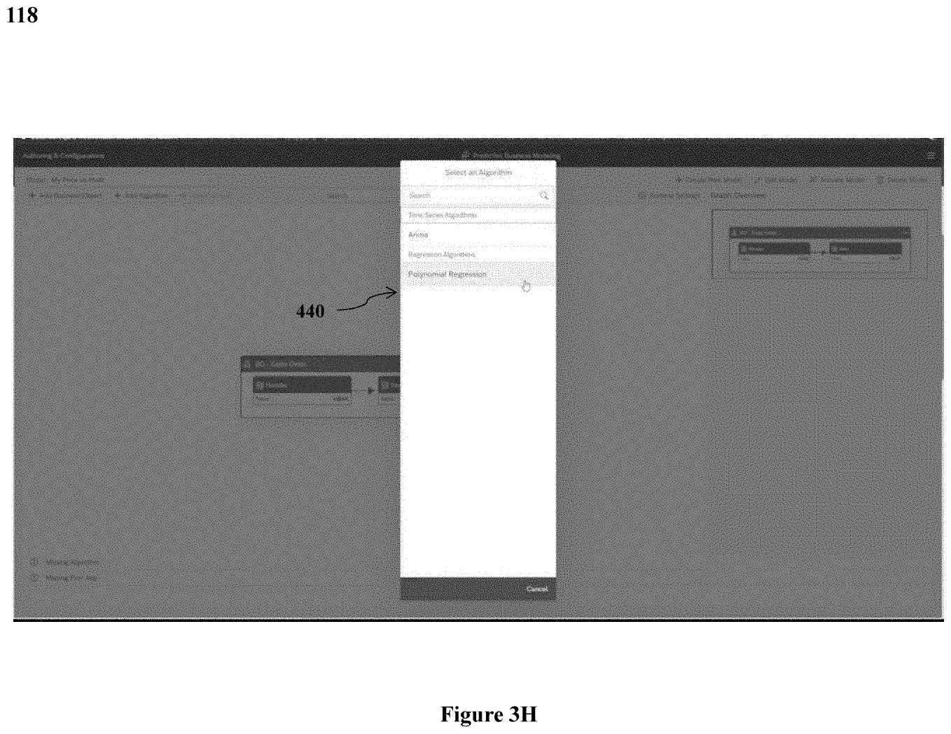

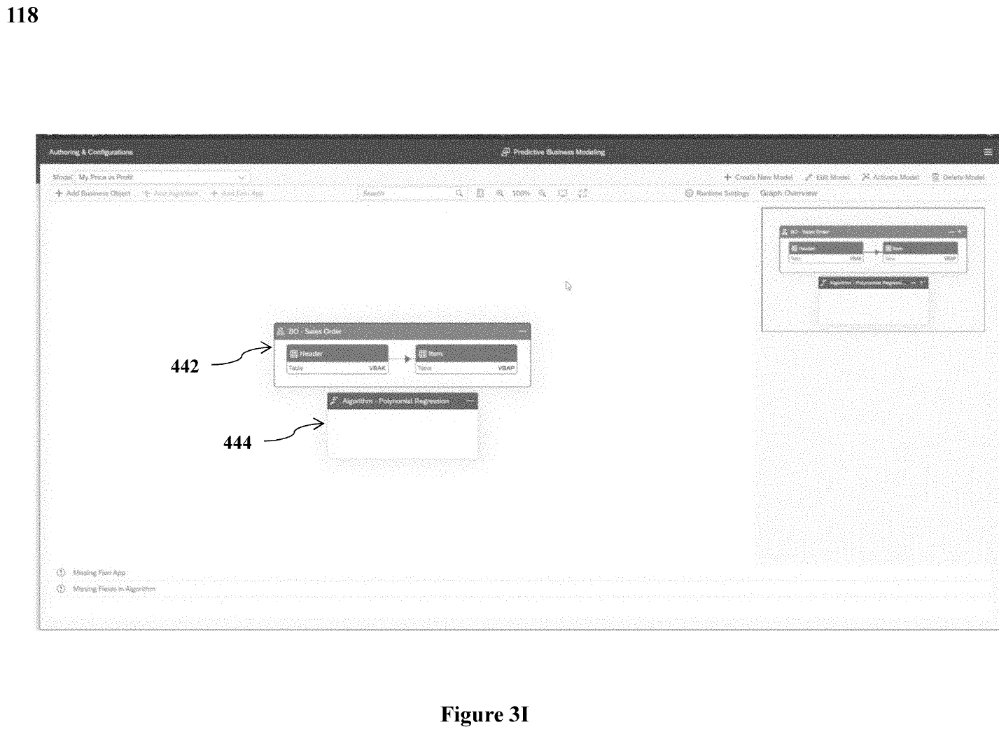

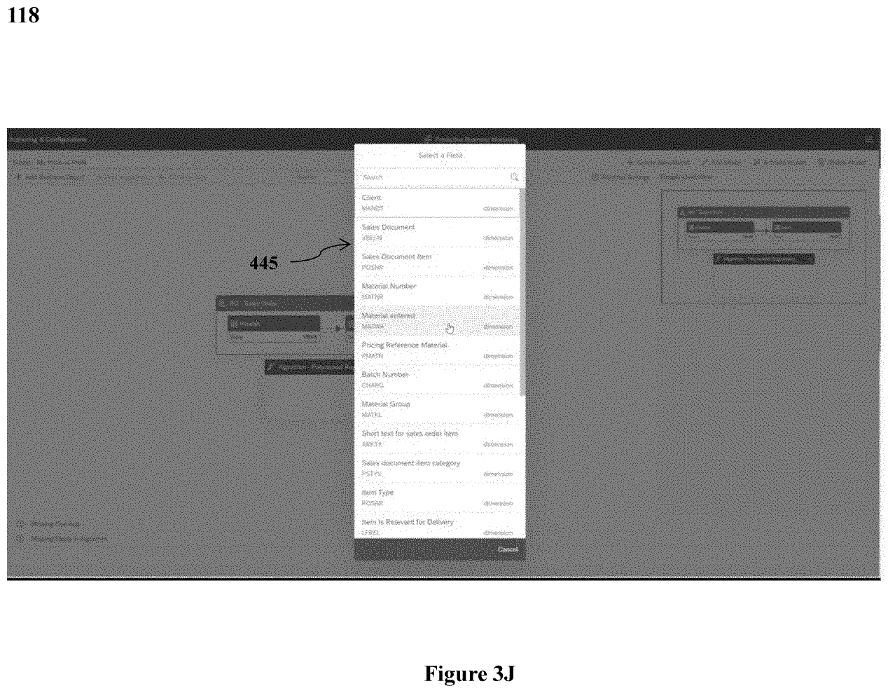

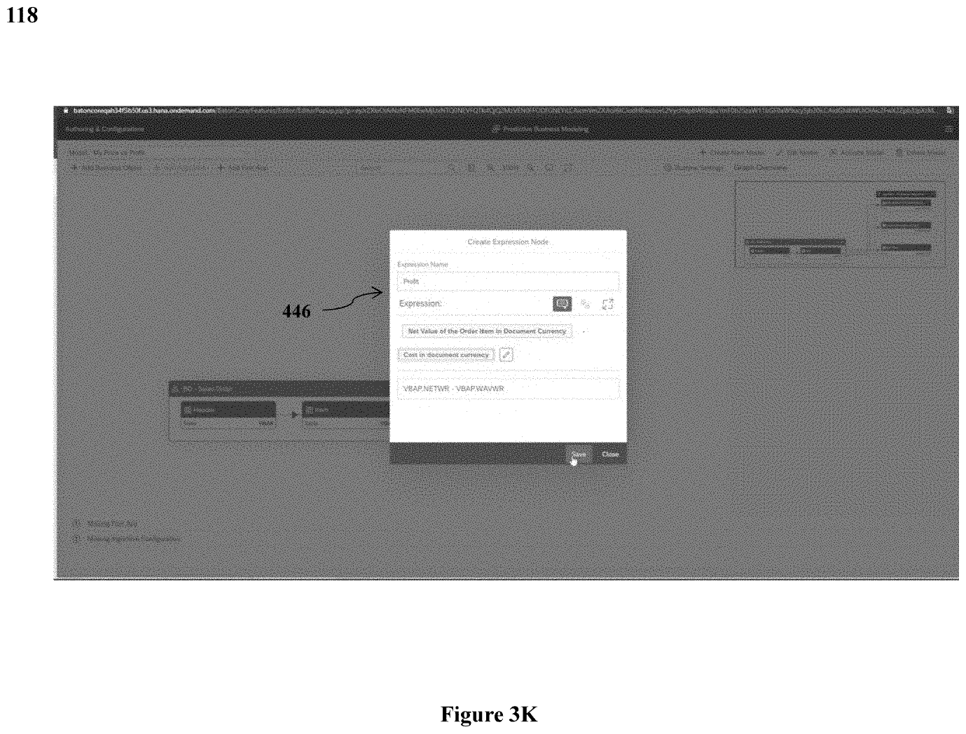

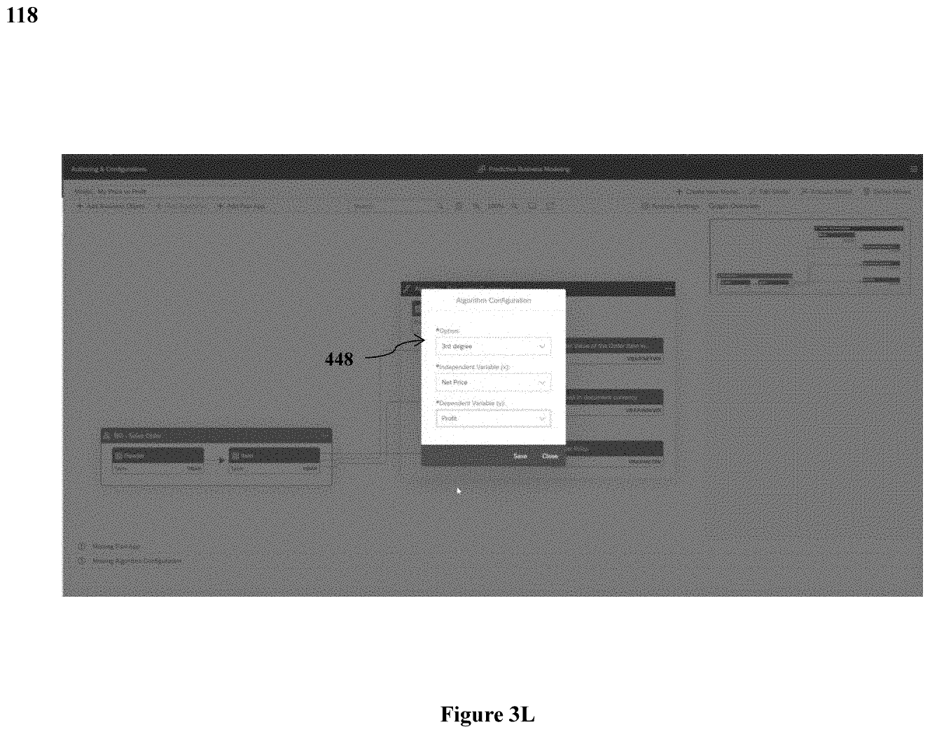

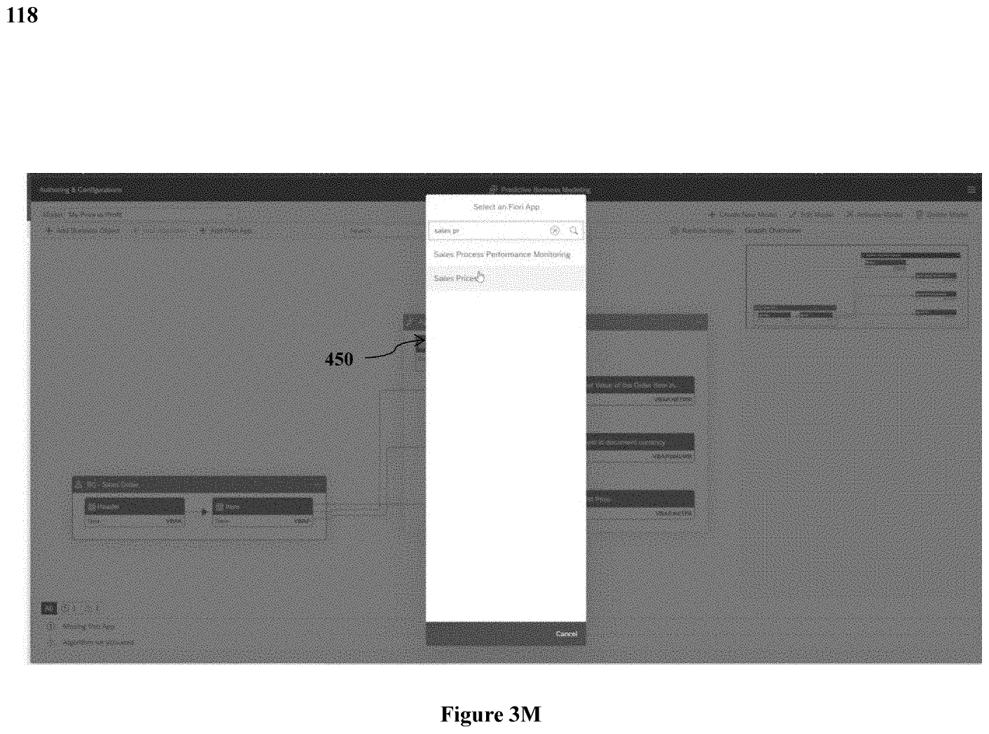

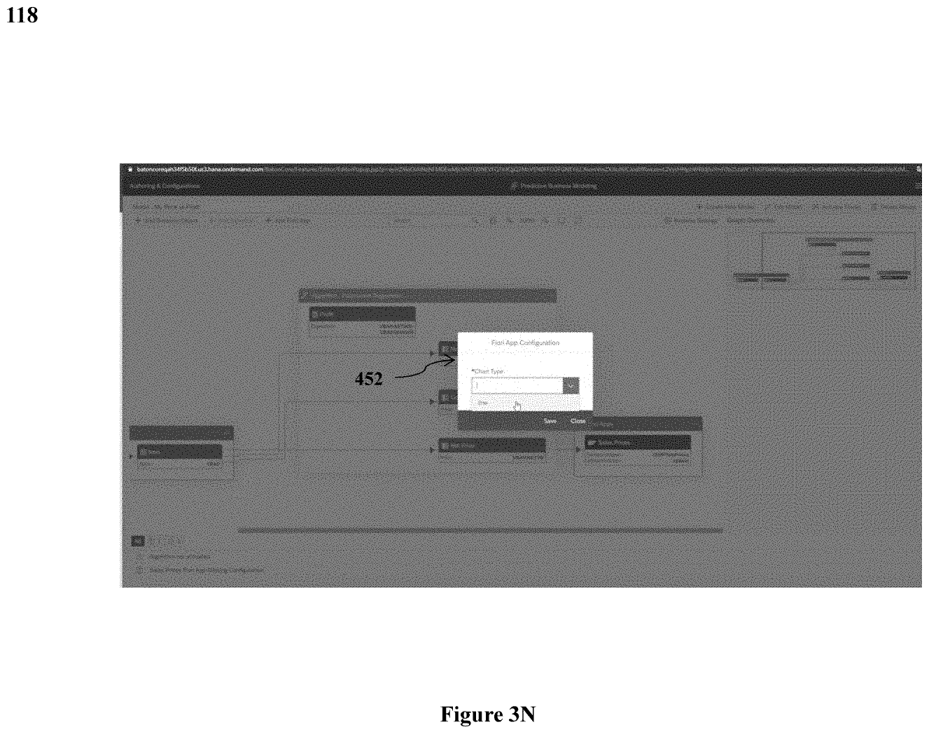

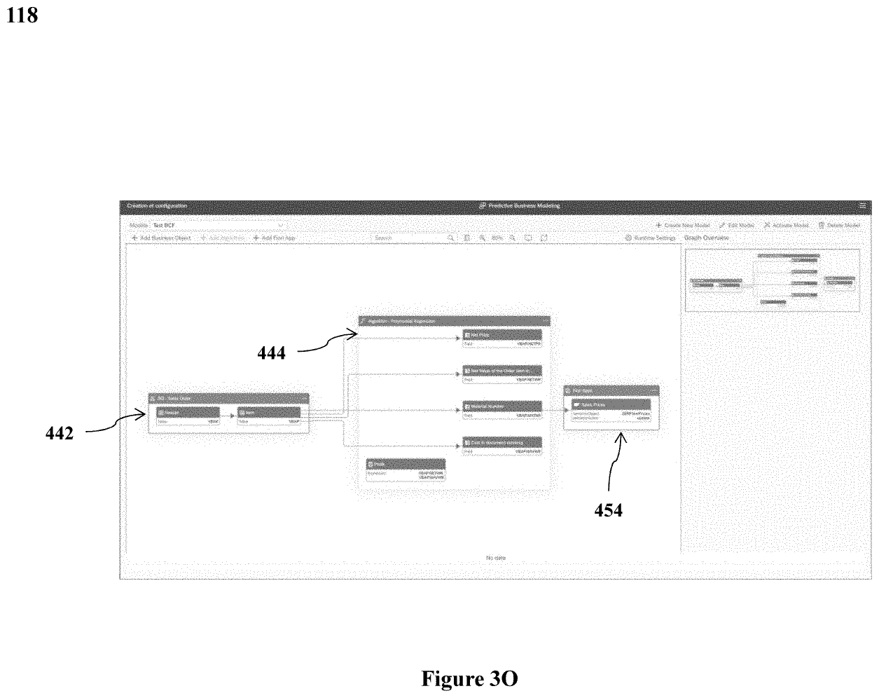

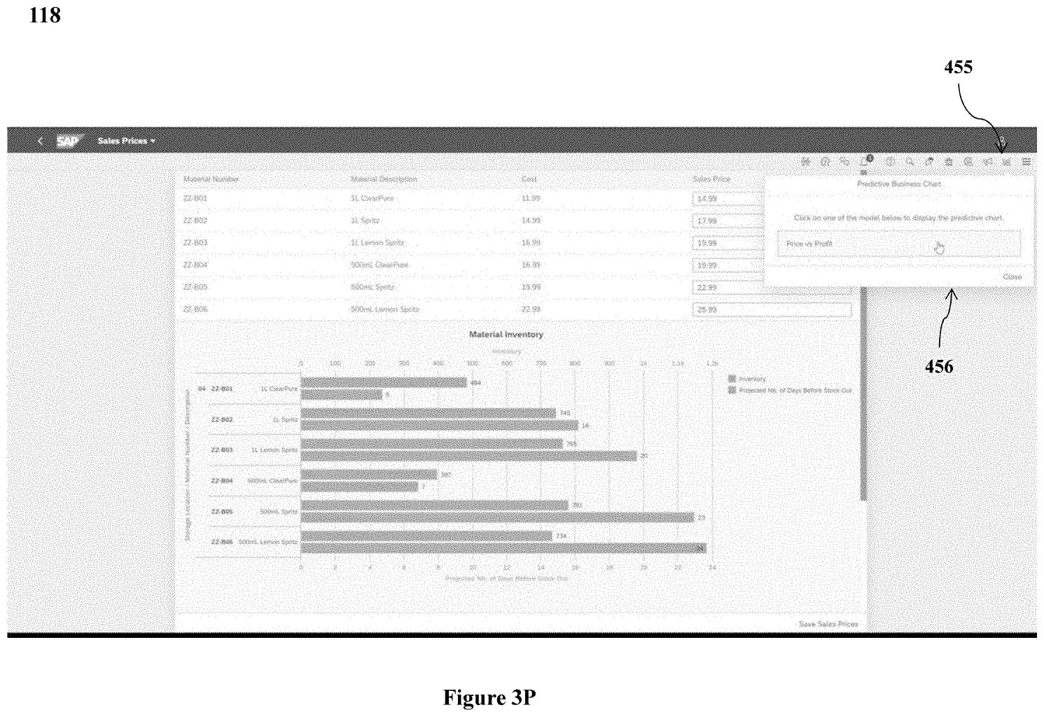

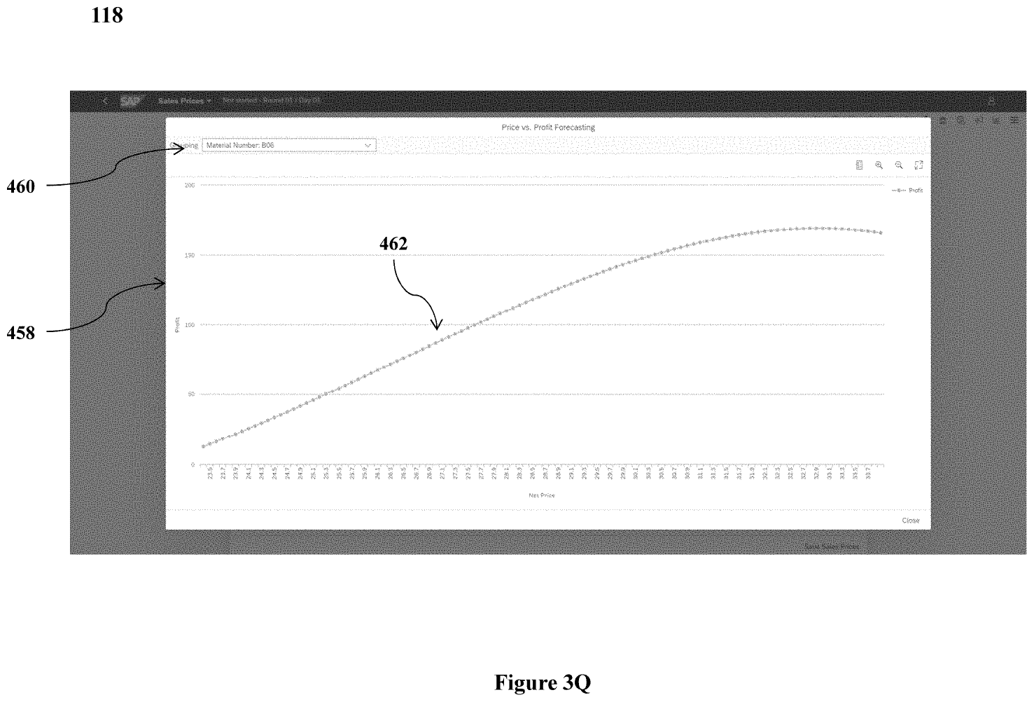

FIG. 3A illustrates an example of the GUI 118 associated with the ERP system 100, in accordance with various embodiments of present disclosure. The GUI 118 may provide the user 116 with many options. By way of example, to access the ERP system 100, in certain embodiments the user 116 may have to validate his/her credentials such that the user 116 is an authentic user of the ERP system 100. To this end, the user may select an option 302 which may prompt the user 116 to enter the credentials such as user identification (ID), password or the like. Once the ERP system 100 verifies the credentials, the user 116 may now be able to access various services associated with the ERP system 100.

Other options provided by the GUI 118 may include but are not limited to guided tours 304, process & IoT viewer 306, intelligent assistant 308, support chat 310, notifications 312, frequently asked questions 314, search 318, collaboration room 320, user settings 322, predictive business 324, and content authoring menu 326.

In certain embodiments, the content authoring menu 326 may provide access to system configuration options. Through content authoring menu 326, the user 116 may be able to configure Fiori magic, create Guiders (Contextual Help), create courses & tutorials, design & develop process flow diagrams, configure intelligent assistant, configure chat support functions, configure translation hub and services, configure landscape transport, access account information. In certain embodiments, the content authoring menu 326 may be expanded to provide further options including guiders 328, configure process & IoT maps 330, configure intelligent assistant 332, configure chat 334, configure system messaging 336, configure translation 338, configure landscape 340, usage analytics 342, configure magic Fiori 344, audit trails 346, predictive business modeling 348, access account information 350, documentation 352, recycle bin 354, and about 356.

It is to be noted that in certain embodiments, the options associated with the content authoring menu 326 may be further expanded. For example, predictive business modeling 348 may be expanded to provide further options such as modeling 358, runtime executive logs 360, and administration settings 362.

Along with the options 302-362, the GUI 118 may also provide a dashboard 364 that includes various host domain applications integrated together such as an overview application 366, a sales application 368, a marketing application 370, or the like. In certain embodiments, the GUI 118 may provide a scrolling option to further display other sub applications such as finance application, planning and procurement application, human resource application or the like.

In one representative scenario, the ERP system 100 may be based on SAP S/4HANA technology. By way of example, the ERP system 100 and the GUI 118 may correspond to distribution of packed water bottles. However, it will be appreciated that the ERP system 100 may not be limited to distribution business requirements, rather the ERP system 100 may include any suitable business requirements including but not limited corporate performance and governance, sales, customer relationship management (CRM), supplier relationship management (SRM), product life cycle management (PLM), supply chain management (SCM), accounting, human resources or the like.

By way of example, in order to set an appropriate selling price of packed water bottles in this representative scenario, the user 116 associated with sales may select the sales application 366. FIG. 3B illustrates an extract of the sales application 368 from the GUI 118. As shown, the extract of the sales application 368 may include a prices and inventory application 368-1 along with other supporting applications embedded with rich analytics to assist in decision-making. Such supporting applications may include but are not limited to sales trend application 368-2, sales analysis application 368-3, product profitability trend 368-4, inventory trend 366-5, geospatial analytics 368-6, or the like.

To change or set an appropriate selling price of a material, the user 116 may select the prices and inventory application 368-1. FIG. 3C illustrates the GUI 118 associated with the prices and inventory application 368-1. As shown, the GUI 118 associated with the prices and inventory application 368-1 may include a material number 402, a material description 404, an infographic 405, a material cost 406, a selling price 408, and a save sales price button 410.

The infographic 405 may represent the present inventory of the materials and an estimate of the number of days before the materials may be out of stock. In certain embodiments, based on the information in the infographic, the user 116 may make a change to the price of certain materials. For example, the user 116 observed that the sale of 1L spritz is less than as planned, due to which the stock of 1L spritz and number of days before it goes out of stock is more than as planned. To this end, the user 116 may want to reduce to the selling price of the 1L spritz in such a manner that the selling price is high enough to ensure a decent margin but low enough to ensure consumer demand against competition. However, to the user 116 may not be an expert business or data analyst to determine the optimal price of its own.

To this end, in certain embodiments, the GUI 118 may facilitate the user 116 to use a previously defined custom predictive model or may generate a new custom predictive model. To generate a new custom predictive model, the user 116 may select the modeling 358 option. FIG. 3D illustrates a GUI associated with the modeling 358 option. As shown, the GUI associated with the modeling 358 includes a model option 420, create new model option 422, edit model option 424, activate model option 426, and delete model option 428 or the like. To create the new custom predictive model, the user 116 may select the create new model option 422. In certain embodiments, as shown in the FIG. 3E, a pop-up window 430 may appear in the GUI 118. The pop-up window 430 may provide a text box to fill with identificator and another text box to fill with the name of the model. By way of example, in order to compute the optimal price, the user 116 may create the new model to analyze price versus profit.

Once the pop-up window 430 is filled with the required information, some additional options may appear in the GUI associated with the modeling 358 option. In order create new custom predictive model, in certain embodiments, it requires a business object such as sales order, purchase order, or the like from which the required data may be collected, a machine learning algorithm to process the data, and a Fiori application where the predicted values may be consumed. As shown in the FIG. 3F, the additional options may include add business object option 432, add algorithm option 434, add Fiori application option 436 among other options. In certain embodiments, as shown in the FIG. 3G, a pop-up window 438 may appear in the GUI 118 as a result of selection of the business object option 432 by the user 116. The pop-up window 438 may provide an option to select the business object from various business objects. In certain embodiments, various business objects may be predefined and the associated database tables may be stored in the database 274. By way of example, in order to analyze price versus profit, the user 116 may select a sales order as the business object.

In order to add a machine learning algorithm, in certain embodiments, the user 116 may select the add algorithm option 434. As a result, as shown in the FIG. 3H, in certain embodiments a pop-up window 440 may appear in the GUI 118. The pop-up window 438 may provide an option to select a suitable machine learning algorithm among different machine learning algorithms In certain non-limiting embodiments, the ERP system 100 may rely on SAP Leonardo Predictive Analysis Library (PAL) to facilitate the user 116 to select a suitable and previously trained machine learning algorithm. In this example, the user 116 may select a linear regression based machine learning algorithm to process the data associated with the sales business object.

FIG. 3I illustrates a selected business object 442 and a selected machine learning algorithm 444. As shown, the selected business object 442 may further include the associated entities such as sales order header, sales order item or the like. In certain embodiments, the user 116 may provide various data fields from the selected business object 442 to the selected machine learning algorithm 444 to process and extract useful information. As such, the data fields may be selected from the database tables stored in the database 274. To add various data fields, in certain embodiments, the user 116 may click on the sales order item in the selected business object 442. As shown in the FIG. 3J a pop-up window 445 may appear in the GUI 118. The pop-up window 445 may provide an option to select and fetching suitable data fields among different data fields. For example, to analyze price versus profit, the user 116 may select the data fields that include net price for one quantity in the order line item, net value for all the quantities in the order line item and the cost in the document.

After selecting various data fields and providing and configuring the selected machine learning algorithm 444 with the data fields, in certain embodiments, the user 116 may create a mathematical expression node. To create the mathematical expression node, the user 116 may click on the selected machine algorithm 444. As shown in the FIG. 3K, a pop-up window 446 may appear in the GUI 118. The pop-up window 446 may provide a text box to name the mathematical expression, for example profit in this case. In certain embodiments, the user 116 may create any suitable mathematical expression such as an arithmetical expression using the selected data fields and suitable arithmetic operators. By way of example, in order to calculate profit, the user 116 may create the arithmetic expression as “net value of the order item in document currency-cost in the document currency”.

Once the mathematical expression is created, the selected machine learning algorithm 444 may be configured to map the data fields to the required inputs. To configure the selected machine learning algorithm 444 may click on the selected machine learning algorithm 444 and may select algorithm configuration option. To this end, as shown in the FIG. 3L, a pop-up window 448 may appear in the GUI 118. In the pop-up window 448, the user 116 may select independent variables and dependent variables as required by the machine learning algorithm. In this example, the user 116 may set net price as independent variable which has its direct impact on the profit hence, setting profit as dependent variable.

After configuring the selected machine learning algorithm 444, in certain embodiments, the user 116 may select add Fiori application option 436. As shown in FIG. 3M, a pop-up window 450 may appear in the GUI 118. In the pop-up window 450, the user 116 may select an appropriate Fiori application, such as sales price in the above example. Further, as shown in the FIG. 3N, the selected Fiori application may be configured using a pop-up window 452. In certain embodiments, the pop-up window 452 may provide a drop-down list including certain options associated with the visualization such as line charts, column charts, bar charts, point charts, pie charts, histograms or the like. The GUI 118 may present the outcome in accordance with the selected visualization option. Such as the line chart in the above example. It is contemplated that the GUI 118 may use any suitable visualization application and Fiori application has been illustrated for the purpose of representation.

In certain embodiments, the user 116 may activate the new custom predictive model by selecting the activate model option 426. In certain embodiments, once the new custom predictive model is activated, the machine learning model may process the data fields associated with the business objects in accordance with the mathematical expression defining the relationship among the data fields to generate predictive values.

In certain embodiments, the query script generator 276 may be configured to generate a SQL script based on the mathematical expression created in the pop-up window 446. In certain embodiments, the database view generator 278 may be configured to generate a database view (e.g. ABAP CDS generation algorithm) using the SQL script generated by the query script generator 276. Further, from the generated database view, in certain embodiments, the OData generator 280 may be configured to generate OData services. FIG. 3O illustrates an activated new custom predictive model.

In order to the use the activated custom predictive model, in certain embodiments, the user 116 may select predictive business chart option 455. As shown in the FIG. 3P, a pop-up window 456 may appear in the GUI 118. The pop-up window 456 may illustrate all the associated custom predictive models along with the newly created and activated custom predictive model. The user may select a suitable custom predictive model, for example “Price vs Profit”. As a result, a pop window 458 may appear in the GUI 118. In certain embodiments, the user 116 may click on a drop-down list 460 to select an item for which the user 116 may be willing to analyze, “Price vs Profit.” For example, for product B06, the predicted values may be presented as visualization 462. In certain embodiments, based on the visualization 462 the user 116 change the selling price of an item.

In certain embodiments, the user 116 may be provided with a notification in the GUI 118 using notifications 312 option. The notifications may include information extracted from the predicted values such as the predicted value is above or below a certain threshold. By way of example, if an item is about to get out of stock and user 116 have previously generated a custom predictive model to predict the stock of the item, a notification may be provided to the user 116 in the GUI 118. In certain embodiments, the predicted values may be stored in the database 274 for further training the machine learning algorithms to further forecasting.

It is contemplated that using the GUI 118, the user 116 may generate any suitable predictive model associated with other applications of ERP system 100 such as for example applications associated with marketing, finance, human resources, or the like without limiting the scope of present disclosure.

Thus by virtue of the ERP environment 260 and the GUI 118 the ERP system 100 may facilitate the user 116 to generate custom predictive models with significantly reduces the time required to build such models using a manual procedure.

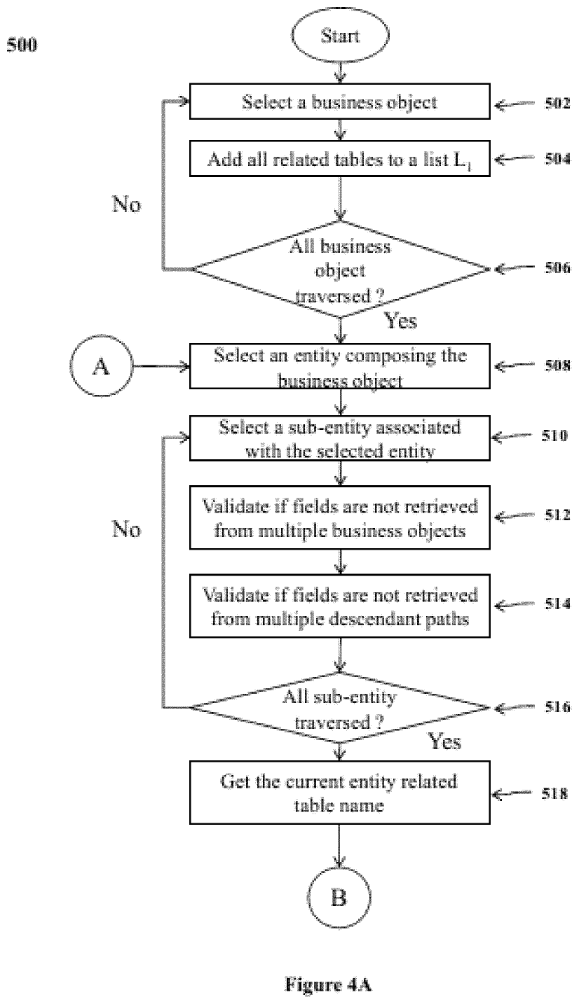

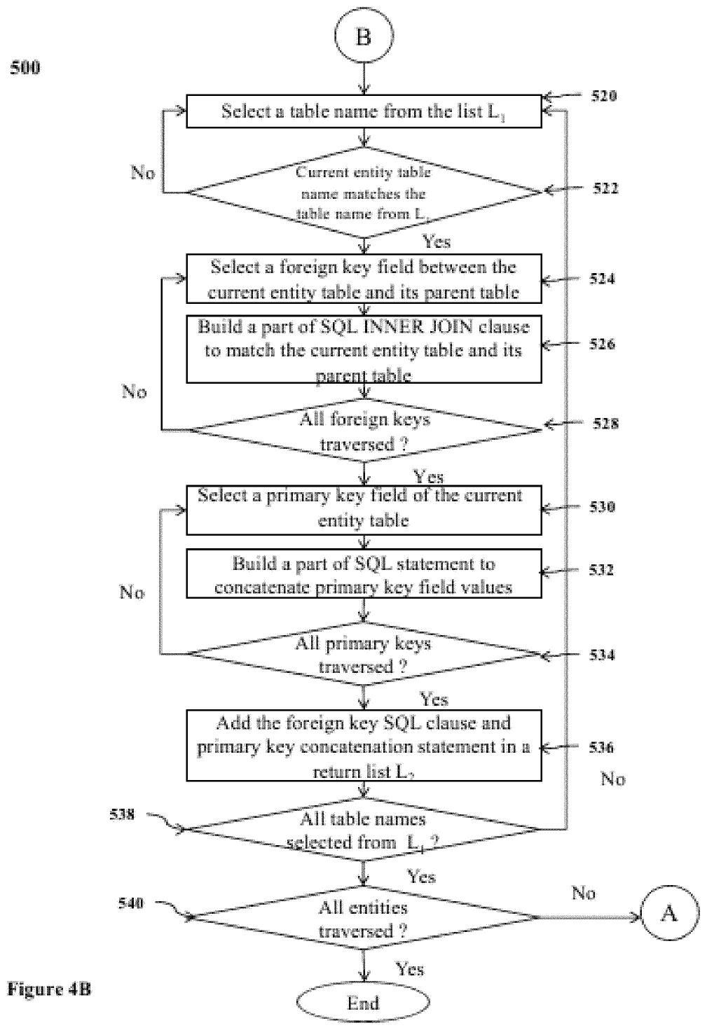

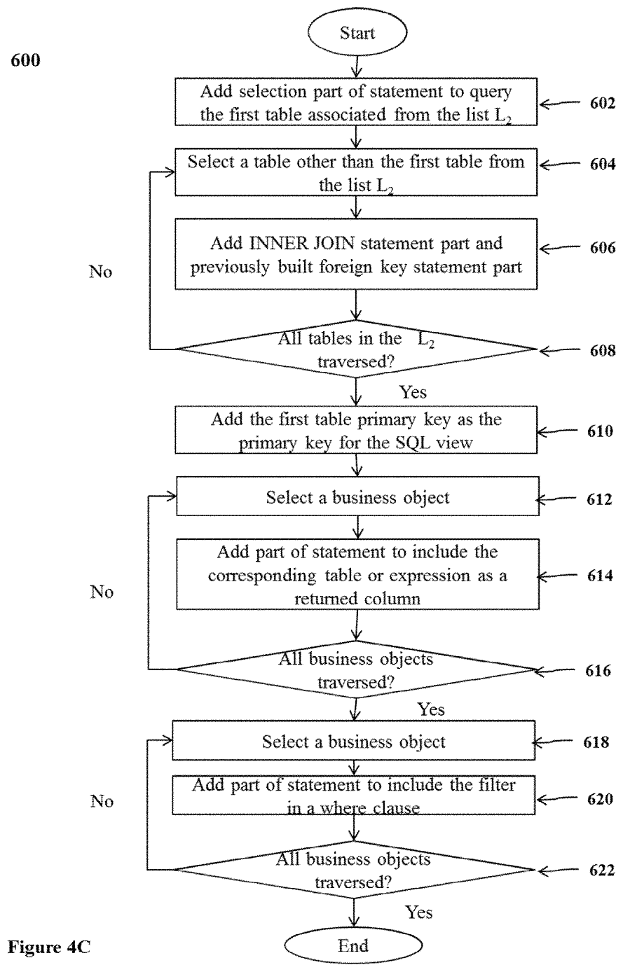

FIGS. 4A-4C depicts flowcharts representing processes corresponding to a generation of SQL scripts and ABAP CDS view implemented on the one or more components of the view generator 272, in accordance with various embodiments of the present disclosure. In particular, a process 500 is implemented on the query script generator 276 and a process 600 is implemented on the database view generator 278.

As shown in the FIG. 4A, the process 500 corresponds to the generation of SQL scripts and begins at step 502 where the query script generator 276 selects a business object. As previously discussed, the user 116 may select a business object (e.g. sales business object) from various business objects in the pop-up window 438. In certain embodiments, the user 116 may select one or more business objects. The query script generator 276 may select the selected business object by the user 116.

The process 500 advances to step 504. At step 504, the query script generator 276 may add all the database tables associated with the selected business objects to a list L₁. In certain embodiments, the associated database tables may be selected from the database 274. The process 500 proceeds to step 506, where the query script generator 276 verifies if all the business objects have been traversed or not. In certain embodiments, the user 116 may select more than one business object, to this end, if all the business objects selected by the user 116 have not been traversed, the process 500 returns to step 502 to select another business object. However, if all the business objects have been traversed, the process advances to step 508.

At step 508, the query generator 276 selects an entity composing the business objects. In certain embodiments, the query generator 276 may select an entity composing the business object selected at step 502. By way of example, if the selected business object is a sales order business object then that associated entities may include sales order header, sales order item or the like.

The process 500 advances to step 510 where the query generator 276 selects a sub-entity associated with the entity selected at the step 508. The process 500 moves to step 512 where the query generator 276 validates if the data fields associated with the sub-entities selected at the step 510 are not retrieved from multiple business objects. If the data fields are retrieved from multiple business objects then, in certain embodiments, an error may be raised else the process 500 advances to step 514.

At step 514, the query generator 276 validates if the data fields associated with the sub-entities selected at the step 510 are not retrieved from multiple descendant paths. If the data fields are retrieved from multiple descendant paths then, in certain embodiments, an error may be raised else the process 500 advances to step 516. At step 516, the query generator 276 verifies if all the sub-entities associated with the entity selected at the step 508 have been traversed or not. If all the sub-entities have not been traversed, the process 500 returns to step 510 to select another sub-entity. However, if all the sub-entities have been traversed, the process 500 advances to step 518.

At step 518, the query generator 276 gets the table name associated with the entity selected at step 508. The process 500 advances to step 520 (As illustrated by FIG. 4B which is a continuation of the process 500) where the query generator 276 selects a table name from the list L₁ generated at step 504. At step 522, the query generator 276 verifies if the table name associated with the entity selected at step 508 matches the table name selected from the list L₁. If both the table names are different, the process 500 returns to step 520 to select another table name from the list L₁. However, if both the table names are same, the process 500 advances to step 524.

At step 524, the query generator 276 selects a foreign key field between the table associated with the entity selected at step 508 and the table selected from the list L₁ (i.e. the parent table) the name of which matches the name of the table associated with the current entity. The process 500 moves to step 526.

At step 526, the query generator 276 builds a part of SQL INNER JOIN clause to match the current entity table and its parent table as selected from the list L₁. At step 528, the query generator 276 verifies if all the foreign key fields between the table associated with the current entity and its patent table have been traversed or not. If all the foreign key fields have not been traversed, the process 500 returns to step 524 to select another foreign key field. However, if all the foreign key fields have been traversed, the process 500 advances to step 530.

At step 530, the query generator 276 selects a primary key field of the current entity table and at step 532, the query generator 276 build a part of SQL statement to concatenate the selected primary key field values. At step 534, the query generator 276 verifies if all the primary key fields of the current entity table have been traversed or not. If all the primary key fields have not been traversed, the process 500 returns to step 530 to select another primary key field. However, if all the primary key fields have been traversed, the process 500 advances to step 536.

At step 536, the query generator 276 adds the foreign key SQL INNER JOIN clause generated at step 526 and the primary key concatenation statement generated at step 532 in a return list L₂. The process 500 advances to step 538 where the query generator 276 verifies if all the table names have been selected from the list L₁ or not. If all the table names have not been selected, the process 500 returns to step 520 to select another table name from the list L₁. However, if all the table names have been selected, the process 500 advances to step 540.

Finally, at step 540, the query generator 276 verifies if all the entities have been traversed or not. If all the entities have not been traversed, the process 500 returns to step 508 to select another entity. However, if all the entities have been traversed, the process 500 ends.

The process 600 corresponds to generate ABAP CDS views from the SQL query scripts generated by the process 500. As shown in the FIG. 4C, the process 600 begins at 602 where the database view generator 278 adds a selection part of a SQL statement to query the first table associated with the list L₂. The process 600 advances to step 604.

At step 604, the database view generator 278 selects a table from the list L₂ other than the first table queried at step 602. The process 600 advances to step 606 where the database view generator 278 adds a part of SQL INNER JOIN the SQL statement and previously generated foreign key SQL INNER JOIN clause at step 526 of the process 500. At step 608, the database view generator 278 verifies if all the tables in the list L₂ have been traversed or not. If all the tables in the list L₂ have not been traversed, the process 600 returns to step 604 to select another table. However, if all the tables in the list L₂ have been traversed, the process 600 moves to step 610.

At step 610, the database view generator 278 adds the primary key associated with the first table queried at step 602 for the SQL view. The process 600 advances to step 612, where the database view generator 278 selects a business object selected by the user 116 in the pop-up window 438. The process moves to step 614.

At step 614, the database view generator 278, for selected business object fields and calculated fields associated with the business object, adds a second part of the SQL statement to include the corresponding first database table and/or mathematical expression defining relationship among the data fields as a return column.

At step 616 the database view generator 278 verifies if all the business objects have been traversed or not. If all the business objects have not been traversed, the process 600 returns to step 612 to select another business object. However, if all the business objects have been traversed, the process 600 moves to step 618.

At step 618, the database view generator 278 again selects a business object selected by the user 116 in the pop-up window 438. The process moves to step 620. At step 620, the database view generator 278, for selection filters, adds a third part of the SQL statement to include the filter in a where clause.

Finally, at step 622, the database view generator 278 verifies if all the business objects have been traversed or not. If all the business objects have not been traversed, the process 600 returns to step 618 to select another business object. However, if all the business objects have been traversed, the process 600 ends.

An example of ABAP CDS view as generated by the process 600 may be provided as:

@AbapCatalog.sqlViewName: ‘ZMLBT_SV_2’
@AbapCatalog.compiler.compareFilter: true
@AbapCatalog.preserveKey: true
@AccessControl.authorizationCheck: #CHECK
@EndUserText.label: ‘Price vs. Profit Forecasting’
@OData.publish: true
define view ZZ_ML_PRICE_VS_PROFIT as select from VBAP as VBAP
inner join /batonsim/time as batonsim_time on VBAP.MANDT = batonsim_{—}
time.mandt and batonsim_time.simuuid < > ″
{
key CONCAT(batonsim_time.simuuid, CONCAT(CONCAT(VBAP.MAN
DT, VBAP.VBELN), VBAP.POSNR)) as primary_key,
batonsim_time.simuuid as simuuid,
SUBSTRING(VBAP.MATNR, 4, 3) as material_number,
VBAP.NETWR as net_value_of_the_order_item_i,
VBAP.WAVWR as cost_in_document_currency,
VBAP.NETPR as net_price,
VBAP.NETWR − VBAP.WAVWR as profit
}

In certain embodiments, the database view generator 278 may be configured to automatically execute (compile) the programming codes associated with the generated ABAP CDS view and store the programming codes in the ERP environment 260 under a specific ABAP package name (e.g. ZMYPREDICTIVE_MODELS).

Once the ABAP CDS view is generated, in certain embodiments, the OData generator 280 may generate OData services from the generated ABAP CDS view. In certain embodiments, the OData generator 280 may be configured to automatically create/generate and activate the associated OData services from the generated OData services without manual inputs from the user 116. In particular, the OData generator 280 may be configured to activate the OData services using: I) default technical service name (e.g. ZZ_ML_PRICE_VS_PROFIT_CDS), II) default external service name (e.g. ZZ_ML_PRICE_VS_PROFIT_CDS), III) version (e.g. 1 or 2 or the like). The OData generator 280 may then create/generate and activate internet communication framework (ICF) node and add a default system alias. During the OData services activation, the OData generator 280 may assign the activated services to certain ABAP packages (e.g. ZMYPREDICTIVE_MODELS).

An example of the OData service generated may be give as:
/sap/opu/odata/sap/ZZ_ML_PRICE_VS_PROFIT_CDS/ZZ_ML_PRICE_V S_PROFIT?format=json

In certain embodiments, the view generator 272 may be further configured to attach the generated ABAP CDS view and OData service to the standard transport system associated with the ERP system 100. So that changes made to ABAP CDS view may be reflected in all the associated host domain applications.

In certain embodiments, the view generator 272 may be further configured to attach the generated OData services to standard security architecture associated with the ERP system 100. As such, certain roles and authorizations must be granted to the user 116 to get access to different resources, transactions, features in the ERP system 100. In certain embodiments, the generated OData Services may comply to this security architecture and the user 116 must get authorizations on generated services to consume them or these authorizations can be applied automatically.

Thus by virtue of the ERP environment 260, the ERP system 100 may provide a user-friendly system to create predictive models within GUI itself. Further, the ERP system 100 may improve accessibility of data across different environments of a computer system.

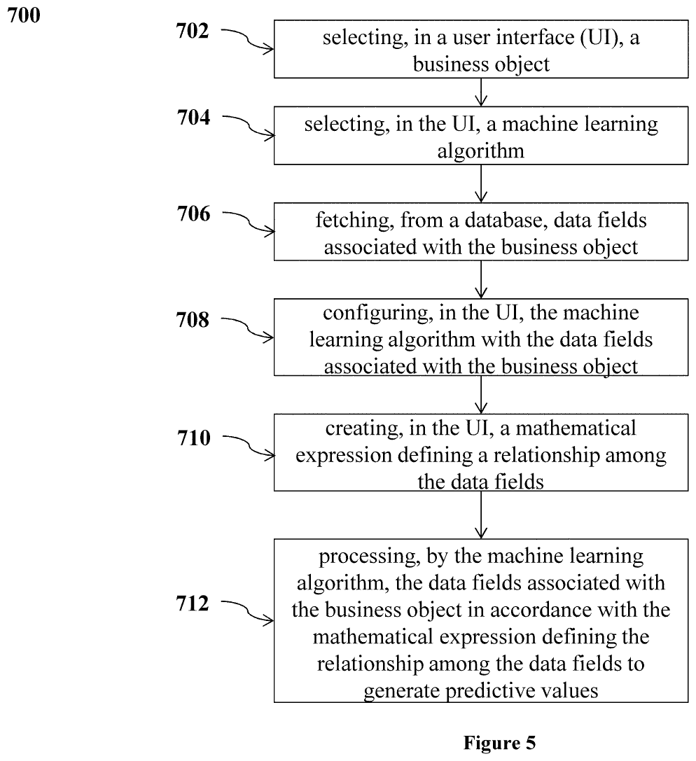

FIG. 5 depicts a flowchart representing a process 700 corresponding to a custom predictive modeling method implemented on the ERP system 100, in accordance with various embodiments of the present disclosure.

As shown, the process 700 begins at step 702. At step 702, a business object is selected in a user interface (UI). As previously noted, in order to create a new custom predictive model, the user 116 may click on the business object option 432 to select a business object from various business objects in the GUI 118. The process 700 advances to step 704.

At Step 704, a machine learning algorithm is selected in the UI. As noted above, the user 116 may click on the add algorithm option 434 to select a suitable machine learning algorithm among different machine learning algorithms in the GUI 118. The process 700 advances to step 706.

At step 706, data fields associated with the selected business object are fetched from the database. As previously discussed, the user 116 may select the data fields associated with the selected business object 442. The selected data fields are then fetched from the database 274. The process 700 advances to step 708.

At step 708, the selected machine learning algorithm is configured with the data fields associated with the selected business objects. As noted above, the selected machine learning algorithm 444 is configured with the data fields associated with the selected business objects 442. The process 700 advances to step 710.

At step 710, a mathematical expression defining a relationship among the data fields is created. As previously discussed, the user 116 may create a mathematical expression node using the selected data fields and suitable mathematical operators. The process 700 advances to step 712.

Finally, at step 712 the machine learning algorithm processes the data fields associated with the business object in accordance with the mathematical expression defining the relationship among the data fields to generate predictive values. As previously noted, the user 116 may activate the new custom predictive model by selecting the activate model option 426. Once the new custom predictive model is activated, the machine learning model may process the data fields associated with the business objects in accordance with the mathematical expression defining the relationship among the data fields to generate predictive values.

It is to be understood that the operations and functionality of the ERP system 100, constituent components, and associated processes may be achieved by any one or more of hardware-based, software-based, and firmware-based elements. Such operational alternatives do not, in any way, limit the scope of the present disclosure.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A method for a generating a custom predictive model, the method comprising:
selecting, in a user interface (UI), a business object;
selecting, in the UI, a machine learning algorithm;
fetching, from a database, data fields associated with the business object;
configuring, in the UI, the machine learning algorithm with the data fields associated with the business object;
creating, in the UI, a mathematical expression defining a relationship among the data fields; and
processing, by the machine learning algorithm, the data fields associated with the business object in accordance with the mathematical expression defining the relationship among the data fields to generate predictive values.

2. The method of claim 1, further comprising configuring a visualization application to provide a visualization of the predictive values.

3. The method of claim 1, further comprising generating, by a query script generator, an SQL query script, wherein the SQL query script is associated with the data fields and the mathematical expression defining relationship among the data fields.

4. The method of claim 3, wherein the generating the SQL query script comprises:
adding database tables associated with the business object to a list L₁;
selecting an entity included in the business object;
validating if the data fields associated with the entity are not retrieved from multiple business objects;
validating if the data fields associated with the entity are not retrieved from multiple descendant paths;
selecting a foreign key field between a database table associated with the entity and a database table in the list L₁ having a same name as that of the database table associated with the entity;
building a part of SQL INNER JOIN clause to match the database table associated with the entity and the database table in the list L₁ having the same name as that of the database table associated with the entity;
selecting a primary key field associated with the database table associated with the entity;
building a part of SQL concatenation statement to concatenate data values associated with the primary key field; and
adding the part of SQL INNER JOIN clause and the part of SQL concatenation statement to a list L₂.

5. The method of claim 4, further comprising generating, by a database view generator, a database view using the SQL query script;

6. The method of claim 5, wherein generating the database view comprises:
adding a first selection part of an SQL statement to query a first database table in the list L₂;
selecting a database table from the list L₂ other than the first database table;
adding a part of SQL INNER JOIN of the SQL statement to the part of SQL INNER JOIN clause;
adding a primary key associated with the first database table for an SQL view;
adding a second part of the SQL statement to include the first database table and/or mathematical expression defining relationship among the data fields; and
adding a third part of the SQL statement to include the selection filters in a where clause.

7. The method of claim 5, wherein the database view is an Application Programming Language (ABAP) Core Data Service (CDS) view.

8. The method of claim 5, further comprising generating and activating, by an OData generator using the database view, OData services.

9. The method of claim 8, wherein activating the OData services includes using: I) default technical service name, II) default external service name, and III) version.

10. The method of claim 8, further comprising activating, by the OData generator, a standard internet communication framework (ICF) node.

11. The method of claim 8, further comprising adding, by the OData generator, a default system alias.

12. The method of claim 8, further comprising assigning, by the OData generator, the activated OData services to ABAP packages.

13. The method of claim 1, further comprising training the machine learning algorithm using the predicted values for further forecasting.

14. The method of claim 1, further comprising providing a user notification when the predictive values: I) fall below a threshold values or II) overpass a threshold values.

15. A system for generating a custom predictive model, the system comprising:
a processor;
a non-transitory computer-readable medium comprising instructions;
the processor, upon executing the instructions, causing the system to:
select, in a user interface (UI), a business object;
select, in the UI, a machine learning algorithm;
fetch, from a database, data fields associated with the business object;
configure, in the UI, the machine learning algorithm with the data fields associated with the business object;
create, in the UI, a mathematical expression defining a relationship among the data fields; and
process, by the machine learning algorithm, the data fields associated with the business object in accordance with the mathematical expression defining the relationship among the data fields to generate predictive values.

16. The system of claim 15, wherein the instructions cause the system to:
generate, by a query script generator, an SQL query script, wherein the SQL query script is associated with the data fields and the mathematical expression defining relationship among the data fields, wherein the generating the SQL query script comprises:
adding database tables associated with the business object to a list L₁;
selecting an entity included in the business object;
validating if the data fields associated with the entity are not retrieved from multiple business objects;
validating if the data fields associated with the entity are not retrieved from multiple descendant paths;
selecting a foreign key field between a database table associated with the entity and a database table in the list L₁ having a same name as that of the database table associated with the entity;
building a part of SQL INNER JOIN clause to match the database table associated with the entity and the database table in the list L₁ having the same name as that of the database table associated with the entity;
selecting a primary key field associated with the database table associated with the entity;
building a part of SQL concatenation statement to concatenate data values associated with the primary key field; and
adding the part of SQL INNER JOIN clause and the part of SQL concatenation statement to a list L₂.

17. The system of claim 16 wherein the instructions cause the system to generate, by a database view generator, a database view using the SQL query script, wherein generating the database view comprises:
adding a first selection part of an SQL statement to query a first database table in the list L₂;
selecting a database table from the list L₂ other than the first database table;
adding a part of SQL INNER JOIN of the SQL statement to the part of SQL INNER JOIN clause;
adding a primary key associated with the first database table for an SQL view;
adding a second part of the SQL statement to include the first database table and/or mathematical expression defining relationship among the data fields; and
adding a third part of the SQL statement to include the selection filters in a where clause.

18. The system of claim 17 wherein the instructions cause the system to generate and activate, by an OData generator using the database view, OData services.

19. The system of claim 18, wherein activating the OData services includes using: I) default technical service name, II) default external service name, III) version.

20. The system of claim 18 wherein the instructions cause the system to:
activate, by the OData generator, a standard internet communication framework (ICF) node;
add, by the OData generator, a default system alias; and
assign, by the OData generator, the activated OData services to ABAP packages.
